(19) United States
(12) Patent Application Publication
(10) Pub. No.: US 2022/0335673 A1
(43) Pub. Date: Oct. 20, 2022

(54) DOCUMENT PROCESSING SYSTEM USING AUGMENTED REALITY AND VIRTUAL REALITY, AND METHOD THEREFOR

(71) Applicants: Wonseok JANG, Seongnam-si (KR); Jun JANG, Seongnam-si (KR); Heok JANG, Seongnam-si (KR); Yun JANG, Seongnam-si (KR)

(72) Inventors: Wonseok JANG, Seongnam-si (KR); Jun JANG, Seongnam-si (KR); Heok JANG, Seongnam-si (KR); Yun JANG, Seongnam-si (KR)

(21) Appl. No.: 17/639,595

(22) PCT Filed: Aug. 27, 2020
(86) PCT No.: PCT/KR2020/011463

§ 371 Date: Mar. 2, 2022

(30) Foreign Application Priority Data
Sep. 9, 2019 (KR) 10-2019-0111186
Sep. 10, 2019 (KR) 10-2019-0112129

(51) Int. Cl. G06T 11/60; H04N 1/00; H04N 1/32

(52) U.S. Cl. CPC G06T 11/60; H04N 1/00875; H04N 1/00403; H04N 1/00392; H04N 1/32406

(57) ABSTRACT

The present invention relates to a document processing system using augmented reality and virtual reality, and a processing method therefor. The document processing system of the present invention shares contents of an object so that one user can write the contents of the object at the location of the object displayed in an augmented reality or virtual reality image to write and store various types of virtual documents and allow other users to view the virtual documents in the augmented reality or virtual image. The document processing system writes and shares the virtual documents by using a mobile terminal capable of expressing augmented reality or virtual reality. The document processing system shares the virtual documents between mobile terminals in a P2P method or a method of using a server. According to the present invention, a new document sharing platform can be implemented to provide a differentiated service to a user by displaying a virtual document written by using augmented reality or virtual reality to be shared in real time.

### TECHNICAL FIELD

The present invention relates to a document processing system, and more specifically, to a document processing system using augmented reality and virtual reality and a method thereof, which creates and stores various types of virtual documents for objects displayed in the augmented reality or virtual reality at the locations of the objects using a mobile terminal that can express the augmented reality or virtual reality, and converts the virtual documents into data and processes the data to be shared with other users in the augmented reality or virtual reality.

### BACKGROUND ART

Generally, various types of documents created using handwriting, computer, or the like are printed on a paper using a printing machine, a printer, a copier, or the like and provided in the form of a book, or produced in the form of an electronic document such as an E-book, a web book, an application book, or the like using a computer program that can be read by a computer, a smart device, or the like. These documents are provided online or offline to be shared with many people.

However, although existing paper documents have an efficient subscription power, they are inconvenient to manage in connection with portability, storage, movement, sharing or the like, and although the electronic documents are easier to manage compared to the paper documents, there is a problem in that the subscription power of the documents is low.

Therefore, it needs to develop a system that can provide a new document type that is easy to manage and allows users to obtain subscription power and sense of reality, unlike the existing paper documents and electronic documents.

### DISCLOSURE OF INVENTION

### Technical Problem

Therefore, the present invention has been made in view of the above problems, and it is an object of the present invention to provide a document processing system using augmented reality and virtual reality and a method thereof, which allows a user to create virtual documents using augmented reality and virtual reality, and share the created virtual documents in augmented reality or virtual reality.

Another object of the present invention is to provide a document processing system using augmented reality and virtual reality and a method thereof, which can secure security of virtual documents by processing user authentication and encryption on the virtual documents created using augmented reality and virtual reality to be shared only with authorized users.

Still another object of the present invention is to provide a document processing system using augmented reality and virtual reality and a method thereof, which can create virtual documents in the form of virtual test sheet data using augmented reality and virtual reality, and use the virtual documents to provide virtual test sheets only to mobile terminal users who use the virtual reality.

### Technical Solution

To accomplish the above objects, according to one aspect of the present invention, there is provided a document processing system for creating contents related to an object or contents desired to be recorded by a user as various types of virtual documents, storing the virtual documents at the location of the object using augmented reality and virtual reality, and allowing other users to share the created virtual documents in augmented reality or virtual reality.

### Advantageous Effects

The document processing system according to an embodiment of the present invention may implement a new document sharing platform and provide a differentiated service to a user by creating and storing virtual documents including contents related to an object or contents desired to be recorded by the user at the location of the object in augmented reality or virtual reality using a mobile terminal capable of expressing augmented reality or virtual reality, and processing to share the virtual documents with other users in augmented reality or virtual reality.

In addition, as virtual documents are allowed to be shared through the process of authenticating a user, encrypting and decrypting the virtual documents, setting a sharing target, and the like, security of the virtual documents can be improved as only authorized users may view the virtual documents, and various documents that require security can be easily viewed and managed. Particularly, documents or the like that require security are shared with corresponding counterparts by exchanging the documents or sharing a signature. In addition, as unauthorized users are not allowed to view the virtual documents, secret documents or the like can be created, and military operations and confidential documents or the like can be stored in the form of virtual documents to secure the security further more.

According to another embodiment of the document processing system of the present invention, as a virtual test sheet is provided only to mobile terminal users who use virtual reality, security problems such as test sheet leakage or the like can be solved by preventing others from seeing the other party's test sheet or writing process. In addition, the cost accompanied with printing, storing, distributing, and disposing test sheets that may occur when existing test sheets are used can be reduced.

### BRIEF DESCRIPTION OF THE DRAWINGS

FIG. 1 is a block diagram showing a network configuration of a document processing system according to the present invention.

FIG. 2 is a block diagram showing the configuration of the mobile terminal shown in FIG. 1.

FIG. 3 is a block diagram showing the configuration of the server shown in FIG. 1.

FIG. 4 is a flowchart illustrating a procedure of creating a virtual document in a document processing system according to the present invention.

FIG. 5 is a flowchart illustrating a procedure of displaying a virtual document on an object displayed in augmented reality or virtual reality of a document processing system according to the present invention;

FIG. 6 is a flowchart illustrating a procedure of sharing a virtual document of a document processing system according to a first embodiment of the present invention.

FIG. 7 is a flowchart illustrating a procedure of sharing a virtual document using a server of a document processing system of the present invention.

FIG. 8 is a flowchart illustrating a procedure of sharing a virtual document in a P2P method between users of a document processing system of the present invention.

FIG. 9 is a flowchart illustrating a procedure of outputting a virtual document of a document processing system according to the present invention.

FIG. 10 is a flowchart illustrating a processing procedure of a document processing system according to a second embodiment of the present invention.

FIGS. 11a and 11b are views showing a virtual test sheet and an input device on an augmented reality or virtual reality screen according to a second embodiment of the present invention.

FIG. 12 is a view for explaining a process of displaying an object of an input device on a virtual test sheet in a document processing system according to a second embodiment of the present invention.

### BEST MODE FOR CARRYING OUT THE INVENTION

The embodiments of the present invention may be modified in various forms, and the scope of the present invention should not be construed as being limited by the embodiments described below.

A document processing system 2 of the present invention according to a first embodiment of the present invention creates and stores contents related to an object or contents desired to be recorded by a user as various types of documents of at least one page, for example, virtual documents of books, reports, notes, memos, letters, articles, notes, scribbles or the like, at the location of the object in augmented reality or virtual reality using mobile terminals 200 and 200a that can express the augmented reality or virtual reality, and processes the virtual documents to be shared with other users in the augmented reality or virtual reality.

That is, in the document processing system 2 of the present invention of the present embodiment, one mobile terminal 200 that creates virtual documents recognizes an input device 300, and displays the input device 300 to create a virtual document at the location of an object displayed in augmented reality or virtual reality, and a user creates and stores contents related to the object or contents desired to be recorded on the displayed virtual document through the recognized input device 300.

In addition, the document processing system 2 according to a first embodiment of the present invention transmits the virtual document created by the mobile terminal 200 to a server 100 to process the virtual document to be shared with the user of another mobile terminal 200a. At this point, the document processing system 2 processes the virtual document created by one mobile terminal 200 to be shares with another mobile terminal 200a in a peer-to-peer (P2P) method between the mobile terminals 200 and 200a or in a method using the server 100.

To this end, in the present embodiment, the document processing system 2 includes a plurality of mobile terminals 200 and 200a, the input device 300, and the server 100. The mobile terminals 200 and 200a and the server 100 are connected to each other through a wireless communication network 4. In addition, the mobile terminals 200 and 200a may be directly connected through the wireless communication network 4 or may be connected through the server 100.

The mobile terminals 200 and 200a are separately described as a first mobile terminal 200 of a user (i.e., a sender) who creates virtual documents, and a second mobile terminal 200a of a user (i.e., a receiver) shared with the created virtual documents. Of course, it is apparent that the second mobile terminal 200a may create virtual documents and the first mobile terminal 200 may be shared with the virtual documents.

The first and second mobile terminals 200 and 200a are provided as an electronic device capable of expressing augmented reality or virtual reality, for example, a smartphone, a tablet phone, a tablet PC, a head mounted display (HMD) device, a hologram display device, or the like, and each user is provided with a mobile terminal. The first and second mobile terminals 200 and 200a include, for example, typical components of a smartphone, an HMD device or the like, for example, a central processing unit (CPU), a memory, a speaker, a microphone, a camera, and the like, and detailed description thereof will be omitted here.

The input device 300 may be diversely provides as a device capable of wireless communication with each of the first and second mobile terminals 200 and 200a, for example, a pen mouse, a keyboard, a touchpad, a sensor board capable of recognizing coordinates, a sensor device capable of inputting a gesture or voice by a user, or the like, or a virtual device that can be recognized by each of the first and second mobile terminals 200 and 200a, for example, a virtual pen mouse, a virtual keyboard, or the like displayed in augmented reality or virtual reality. Accordingly, when creating a virtual document, each of the first and second mobile terminals 200 and 200a receives input data from the input device 300, or recognizes an input operation of the input device 300 or a voice according to a gesture, handwriting, voice, or the like using a camera, a microphone, a sensor, or the like, and activates a function corresponding to the gesture or voice (e.g., retrieval of a previously stored document, or the like) or generates input data through the input operation or the voice.

Specifically, the first and second mobile terminals 200 and 200a receive augmented reality contents or virtual reality contents from the server 100 and store the received contents therein. The first and second mobile terminals 200 and 200a display various types of objects for creating and sharing virtual documents, for example, a specific place, objects, buildings, monuments, landmarks and the like located at the specific place, natural environments such as seas, mountains, sky and the like, tangible and intangible target objects having a story related to the user himself/herself, target objects (or locations) desired to be recorded by the user, and the like, on an image of augmented reality or virtual reality using the stored augmented reality contents or virtual reality contents. At this point, a plurality of objects is displayed at different locations in the augmented reality or virtual reality image according to the current location of the user.

When a user creates a virtual document at the location of an object displayed in augmented reality or virtual reality, or retrieves a previously created document and converts the document into a virtual document, and displays the virtual document at the location of the object, the first and second mobile terminals 200 and 200a process the virtual document so that other users may share and confirm the virtual document with each other in augmented reality or virtual reality. In addition, the first and second mobile terminals 200 and 200a may convert and store the virtual document displayed in augmented reality or virtual reality as data of various formats as needed, or output the converted data to a printing device (not shown) such as a printer or the like to be printed.

The first mobile terminal 200 synchronizes and recognizes the input device 300 to create a virtual document. The first mobile terminal 200 sets a display location of the virtual document to be displayed at each location of the objects included in the augmented reality or virtual reality image from the recognized input device 300. At this point, when an object desired by the user is displayed in the augmented reality or virtual reality image, the first mobile terminal 200 selects the object, and when an object desired by the user is not displayed, the user may move to a specific location in the augmented reality or virtual reality image and select a displayed object or may create a new object for creating a virtual document. In addition, when the moving direction, angle, and position of the input device 300 are recognized and a display location of the virtual document is set, the first mobile terminal 200 may display the display location in the image of augmented reality or virtual reality to inform the user.

The first mobile terminal 200 creates a virtual document by recognizing an object included at the set display location of the virtual document, and inputting contents related to the recognized object or contents desired to be recorded by the user through the input device 300. At this point, the first mobile terminal 200 receives input data from the input device 300, or generates input data by recognizing an object or a user's gesture according to an input operation (e.g., when handwriting is input) of the input device 300 or recognizing a user's voice through a microphone, and creates a virtual document through the input data and processes the virtual document to be shared in real-time in augmented reality or virtual reality.

The first mobile terminal 200 may select any one of documents of various formats previously stored as, for example, a Hangul (HWP) file, Word file, PDF file, or the like using the input device 300, select and convert a part or all of the selected document into an image or text, converts the image or text into a virtual document, and insert or attach the converted virtual document to be displayed at the location of the corresponding object in the augmented reality or virtual reality image. In addition, the first mobile terminal 200 may recognize a user's gesture corresponding to a function capable of retrieving any one of previously stored documents of various formats using a camera, a sensor, or the like, and activate a function of selecting any one of the previously stored documents of various formats through the gesture. In this case, the user's gesture may be set in various ways, for example, a gesture of rotating a finger in the clockwise or counterclockwise direction, a gesture of double-clicking a corresponding object with a finger, and a gesture of dragging a corresponding object with a finger in any one among up, down, left, and right directions, and is recognized through a camera or a sensor of the first mobile terminal 200. In addition, the first mobile terminal 200 may recognize user's voice using a microphone, and process a function of retrieving any one among the previously stored documents of various formats or create input data to be input into the virtual document through the voice. It is apparent that the speech recognition may process a function corresponding to a word of the recognized voice using an already opened Speech to Text (STT) technique, or generate input data by converting the recognized voice into text.

The first mobile terminal 200 processes user authentication using personal information, terminal information, or the like of the user. When the user authentication is completed, the first mobile terminal 200 may determine whether there is a previously created virtual document of a corresponding object, create a new virtual document or select a previously created document and view the contents of the object depending on the existence of the virtual document, edit the virtual document by changing, deleting, adding, or updating, and store the created or edited virtual document. At this point, when the previously created virtual document is already encrypted, the first mobile terminal 200 processes the virtual document to view, edit and store by inputting encryption information.

The first mobile terminal 200 receives input data from the input device 300, recognizes an input operation of the input device 300, or recognizes a user's voice using a microphone and displays them on the virtual document in real-time. At this point, when the input device 300 is a device capable of performing wireless communication, the first mobile terminal 200 receives input data in real-time through a wireless communication network, and when the input device 300 is a virtual device, the first mobile terminal 200 recognizes an input operation of the input device 300 from an image captured using a camera, recognizes an input operation of the input device 300, i.e., a user's gesture, using a sensor, or recognizes a user's voice using a microphone, and generates input data using them.

When the virtual document is created or edited, the first mobile terminal 200 may input and store password information. For example, when the virtual document is created to be shared with all users, it does not need to be encrypted. However, when the virtual document is created to be shared only with specific users, i.e., authorized users, the virtual document is encrypted by inputting password information recognized by the authorized users for security management, and transmitted to the server 100 or the second mobile terminal 200a. At this point, the first mobile terminal 200 sets first object information, which includes three-dimensional coordinates or the like indicating the location of the object (or the location of the virtual document) in the augmented reality or virtual reality image, and a sharing target, and transmits the first object information and the sharing target together with second object information including created sharing list information. Here, the second object information may include user information of a sender who provides the shared virtual document, user information of a receiver who receives the shared virtual document, and a sharing time indicating a time until the virtual document is destroyed.

In order to share the virtual document with the second mobile terminal 200a, the first mobile terminal 200 authenticates whether the user of the second mobile terminal 200a is a user to share the virtual document with. When the virtual document is shared in a P2P method, the first mobile terminal 200 processes communication synchronization, whether the location of an object corresponding to the virtual document matches, and synchronization of the location with the second mobile terminal 200a. When the virtual document is shared using the server 100, the first mobile terminal 200 processes encryption and decryption on the virtual document in association with the second mobile terminal 200a.

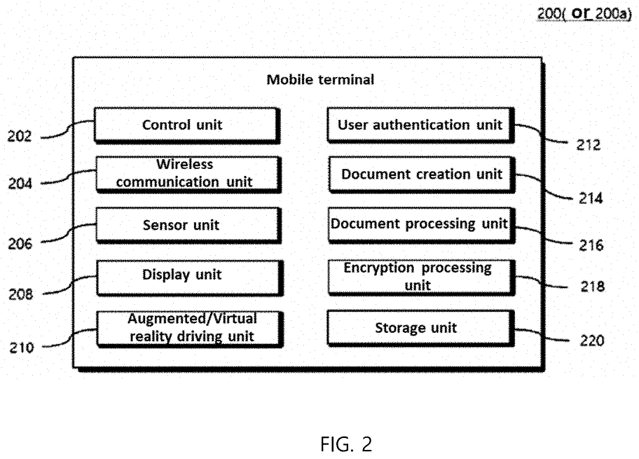

As shown in FIG. 2, the mobile terminal 200 includes a control unit 202, a wireless communication unit 204, a sensor unit 206, a display unit 208, an augmented/virtual reality driving unit 210, a user authentication unit 212, a document creation unit 214, a document processing unit 216, an encryption processing unit 218, and a storage unit 220.

The control unit 202 controls to process the overall operation of the mobile terminal 200. That is, the control unit 202 controls the wireless communication unit 204, the sensor unit 206, the display unit 208, the augmented/virtual reality driving unit 210, the user authentication unit 212, the document creation unit 214, the document processing unit 216, the encryption processing unit 218, and the storage unit 220 to organically interconnect their functions with each other, so that the mobile terminal 200 recognizes an input or an input operation of the input device 300 and processes to create a virtual document at the location of an object in augmented reality or virtual reality, and processes the virtual document to be shared by displaying the created virtual document in augmented reality or virtual reality in real-time to allow the mobile terminal 200a of another user to view or write the virtual document. At this point, when the mobile terminal 200a of another user writes the shared virtual document, it may include, for example, that another user adds contents to the virtual document or inserts his or her opinion in the form of a reply.

The wireless communication unit 204 is connected to the second mobile terminal 200a and the server 100 through the wireless communication network 4. The wireless communication unit 204 is connected to the input device 300 when the input device 300 is a device capable of wireless communication. The wireless communication unit 204 receives augmented reality contents or virtual reality contents from the server 100 and transmits a virtual document to the second mobile terminal 200a and the server 100 under the control of the controller 202.

The sensor unit 206 includes at least a camera, a microphone, and a sensor (e.g., a motion sensor, a location sensor, or the like) for recognizing input operations of the input device 300. For example, when a virtual document is created by the input device 300, the camera captures an image according to the position and movement of the input device 300. The microphone recognizes user's voice.

The sensor recognizes an input operation of the input device 300 or a gesture of a user (or object) according to the input operation. The sensor unit 206 recognizes various input operations of the input device 300, e.g., a gesture of a user (or an object) according to document retrieval, key input, or handwriting, and a voice or the like corresponding thereto.

The display unit 208 displays an image of augmented reality or virtual reality with respect to the current location of the user. The display unit 208 displays a plurality of objects in the image of augmented reality or virtual reality, and displays the virtual document created by the input device 300 at the location of the object. The display unit 208 may display various information or an interface screen for inputting various information according to the virtual document creation and sharing process of the present invention. The display unit 208 displays, for example, objects (e.g., a pen mouse, a keyboard, a user's finger, and the like) of the input device 300 captured by the camera in the image of augmented reality or virtual reality. At this point, the display unit 208 outputs images on different layers, and processes the images by chroma-key processing or the like to display the objects and the virtual document not to overlap each other. When the mobile terminal 200 is, for example, an HMD device, the display unit 208 may output and display the image of augmented reality or virtual reality on a screen or the like.

The augmented/virtual reality driving unit 210 drives augmented reality contents or virtual reality contents to be displayed on the display unit 208, and drives a plurality of objects to be displayed in correspondence to the current location of the user. The augmented/virtual reality driving unit 210 drives a virtual document converted from a document previously stored in a storage unit (not shown) or a virtual document created in real-time to be displayed in the image of augmented reality or virtual reality. At this point, the augmented/virtual reality driving unit 210 scans to set a display location of the virtual document in the image of augmented reality or virtual reality from the input device 300, and when the display location of the virtual document is set, it drives to inform the user of the corresponding display location in the image of augmented reality or virtual reality. The augmented/virtual reality driving unit 210 drives the objects of the input device 300 captured by the camera to be displayed on the upper layer of the displayed virtual document.

The user authentication unit 212 receives user information of the first mobile terminal 200 to create and share a virtual document, or processes user authentication using terminal information. At this point, the user authentication unit 212 confirms whether a corresponding user is a sharing target through the server 100. In addition, when the virtual document is shared between the first and second mobile terminals 200 and 200a in a P2P method, the user authentication unit 212 confirms whether the user is a user set in the sharing list information.

The document creation unit 214 selects an object displayed in the augmented reality or virtual reality image, and creates a virtual document to be written at the location of the selected object. At this point, the document creation unit 214 generates input data by recognizing input data of the input device 300 or an input operation (e.g., handwriting or the like) according to an input operation of the input device 300, and inputs the input data so that the virtual document displayed in the augmented reality or virtual reality image may be displayed and shared in real-time. The document creation unit 214 selects any one of documents of various formats previously stored in the storage unit using the input device 300, and selects a part or all of the selected document and inserts or attaches the selected part to a virtual document that will be created.

The document creation unit 214 may select a virtual document previously created at the location of an object, edit the selected virtual document by changing, deleting, adding, or updating, and store the edited virtual document. The virtual document creation unit 214 may create a new virtual document at the location of a new object desired by the user in the augmented reality or virtual reality image.

The document processing unit 216 processes the virtual document created by the document creation unit to be shared in the augmented reality or virtual reality image. The document processing unit 216 shares the created virtual document with other users in real-time using the first object information of the object on which the virtual document is displayed and the second object information including the sharing list information. That is, the document processing unit 216 shares the virtual document by determining whether another user is included in the sharing list information, and determining whether the location of the object where the virtual document is shared matches. The document processing unit 216 processes user authentication and sharing authentication between the mobile terminals 200 and 200a, and synchronization of communication, location of object, and the like to share the virtual document between the users of the mobile terminals 200 and 200a using a P2P method or the server 100. The document processing unit 216 processes the created virtual document to be converted into an image or text by a user who is authorized to share the virtual document so that the virtual document may be converted into a document of another format or to be printed.

When user authentication is processed using user information, terminal information, and the like previously stored in the storage unit 220, the encryption processing unit 218 encrypts the virtual document by inputting a password into the virtual document. When the virtual document is shared, the encryption processing unit 218 encrypts the virtual document by inputting a password into the virtual document in response to the sharing target so that only authorized users may view the virtual document. The encryption processing unit 218 decrypts the encrypted virtual document as an authorized user inputs a password. The encryption processing unit 218 transmits third object information (sharing authentication information) for confirming that the user is a sharing target to the server 100 when sharing is authenticated.

Then, the storage unit 220 stores user information including at least the user's personal information, biometric information about a fingerprint, an iris and the like, first object information, second object information (sharing list information), password information, third object information (sharing authentication information), and the like. The storage unit 220 may store documents created by various existing computer programs in various formats to be retrieved, inserted, and attached to a virtual document, for example, MS-Word documents, PDF documents, and the like.

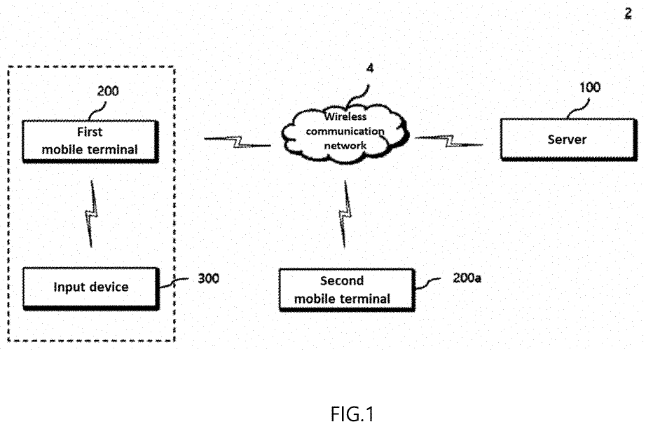

Referring to FIG. 1 again, the input device 300 is set to able to perform wireless communication with the mobile terminals 200 and 200a, and synchronized with the mobile terminals 200 and 200a so that the position of a pointer or a keyboard, which is displayed on the image in augmented reality or virtual reality, or a user's voice may be recognized. When the input device 300 is synchronized with the mobile terminals 200 and 200a, the input device 300 transmits input data according to the contents related to the objects in the displayed virtual document, the contents desired to be recorded by the user, and the like to the mobile terminals 200 and 200a in real-time, or the mobile terminals 200 and 200a input data generated by recognizing an input operation or a voice into the virtual document in real-time. At this point, when the input device 300 is a pen mouse, a keyboard, or a touchpad, the input device 300 transmits the input data to the mobile terminals 200 and 200a through the wireless communication network 4 in real-time, and when the input device 300 is a virtual pen mouse or a virtual keyboard, the mobile terminals 200 and 200a recognize information, such as the coordinates of the pointer position, the moving axis, and the like according to the input operation of the virtual pen mouse, or characters input from the virtual keyboard in real-time by recognizing an image captured by a camera or an object sensed by a sensor, for example, the position of a virtual pen mouse, a virtual keyboard, or a user's finger.

When a virtual input space for writing answers is displayed on a virtual test sheet by the mobile terminal 200 after the input device 300 is synchronized with the mobile terminal 200, answers are written in the input space, and input data is transmitted to the mobile terminal 200 in real-time. At this point, when answers are written by handwriting using a virtual pen mouse or the like, the input device 300 recognizes spatial coordinates and object matching information corresponding to the operation of the input device according to the handwriting, and transmits the recognized information as input data. Of course, it is possible to recognize handwriting according to movement of the virtual pen mouse in an image captured by the camera of the mobile terminal 200, and transmit input data to the mobile terminal 200, or recognize a voice using a microphone and transmit input data. In addition, when the input device 300 is a virtual keyboard, the position of a user's finger is recognized using the camera of the mobile terminals 200 and 200a, and a position corresponding to each input character is recognized and transmitted as input data. The data input by the input device 300 in this way is provided so that the mobile terminals 200 and 200a may display the data in the virtual document in real-time.

The input device 300 may write input data of the virtual document in the form of two-dimensional or three-dimensional characters in augmented reality or virtual reality. In this case, the input device 300 generates input data by including two-dimensional planar coordinates or three-dimensional spatial coordinates, and transmits the input data to the mobile terminals 200 and 200a or recognizes the input data.

In addition, the server 100 is provided with augmented reality contents or virtual reality contents for creating and sharing a virtual document using augmented reality or virtual reality, and provides the contents to the mobile terminals 200 and 200a through the wireless communication network 4. At this point, the server 100 may receive user information, terminal information, and the like for each of a plurality of mobile terminals 200, and register and manage information on the users, i.e., senders and receivers.

The server 100 authenticates users of the first and second mobile terminals 200 and 200a to determine whether the users are a user who has created the virtual document or a sharing target. The server 100 receives the created virtual document and the first and second object information of the position where the virtual document is created from the first mobile terminal 200, and stores the virtual document and the first and second object information. The server 100 transmits notification information informing that the virtual document is shared with the second mobile terminal 200a included in the sharing list information to authenticate whether the user is a sharing target.

When the second mobile terminal 200a is approved as a sharing target by the sharing authentication, the server 100 transmits the first object information indicating where the virtual document is located and the virtual document to the second mobile terminal 200a. At this point, when the virtual document is encrypted, the server 100 may transmit encryption information or an encryption key to the second mobile terminal 200a to decrypt the virtual document.

The server 100 processes to share the created or edited virtual document between the mobile terminals 200 and 200a in real-time. The server 100 determines and manages sharing states such as whether the virtual document is shared between the mobile terminals 200 and 200a, the sharing time, the viewing time, the destroying time, and the like, receives the virtual document from the mobile terminals 200 and 200a, and stores and manages the virtual document together with a hash key of the virtual document, sharing state information, and the like to prevent forgery and falsification of the virtual document.

When the virtual document is shared between the mobile terminals 200 and 200a in a P2P method, the server 100 stores and manages the virtual document to prevent forgery and falsification, and when the virtual document is shared via the server 100 itself, the server 100 processes all functions from creation to sharing of the virtual document, for example, user authentication, object location matching, sharing authentication, encryption and decryption of the virtual document, storage and management of the virtual document, and the like, using various information such as the user information, the first object Information, the second object information (sharing list information), third object information (sharing authentication information), the encryption information, and the like.

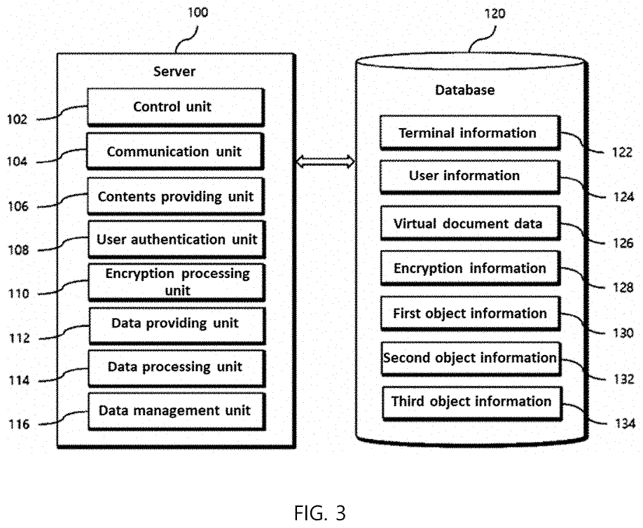

As shown in FIG. 3, the server 100 of the embodiment includes a control unit 102, a communication unit 104, a contents providing unit 106, a user authentication unit 108, an encryption processing unit 110, a data providing unit 112, a data processing unit 114, a data management unit 116, and a database 120.

The control unit 102 controls to process the overall operation of the server 100. That is, the control unit 102 interworks with the mobile terminals 200 and 200a to control the functions of the communication unit 104, the contents providing unit 106, the user authentication unit 108, the encryption processing unit 110, the data providing unit 112, the data processing unit 114, the data management unit 116, and the database 120 to be organically processed with the others.

The communication unit 104 processes data communication with a plurality of mobile terminals 200 and 200a through the wireless communication network 4. The communication unit 104 transmits augmented reality contents or virtual reality contents to the mobile terminals 200 and 200a, and receives user information, terminal information, and the like from the mobile terminals 200 and 200a. The communication unit 104 receives a created virtual document from the first mobile terminal 200 and transmits the virtual document to the second mobile terminal 200a of a sharing target. The communication unit 104 receives sharing list information, first object information, third object information (sharing authentication information), and encryption information from the first mobile terminal 200. The communication unit 104 receives the third object information (sharing authentication information), object location information of a shared virtual document, and the like from the second mobile terminal 200a.

The contents providing unit 106 is provided with augmented reality contents or virtual reality contents to display an object in augmented reality or virtual reality and to create or view a virtual document at the location of the displayed object, and provides the augmented reality contents or the virtual reality contents to the mobile terminals 200 and 200a through the communication unit 104. The contents providing unit 106 provides augmented reality contents or virtual reality contents corresponding to the current locations of the mobile terminals 200 and 200a to select an object at the corresponding position.

The user authentication unit 108 receives user information and terminal information from each of the mobile terminals 200 and 200a, and authenticates whether the user is a virtual document creator or a sharing target. The user authentication unit 108 authenticates whether the mobile terminal 200a is a user included in the sharing list information. When the user of the mobile terminal 200a is authenticated to share the virtual document and the shared virtual document is encrypted, the user authentication unit 108 processes authentication for decryption of the virtual document.

The encryption processing unit 110 generates and stores encryption information and an encryption key in response to the mobile terminals 200 and 200a for which the user authentication has been completed. The encryption processing unit 110 processes to encrypt and decrypt a virtual document using a password input or an encryption key. When the sharing list information matches between the mobile terminals 200 and 200a and sharing authentication is processed, the encryption processing unit 110 approves to view the encrypted virtual document.

The data providing unit 112 prepares sharing list information for a user, i.e., a sharing target, who desires to share a virtual document created by the mobile terminal 200. The data providing unit 112 authenticates whether the mobile terminal 200a is a sharing target. When the virtual document is shared in a P2P method, the data providing unit 112 synchronizes communication, object location, and virtual document between the mobile terminals 200 and 200a. The data providing unit 112 processes to share the virtual document between the mobile terminals 200 and 200a in real-time.

The data processing unit 114 manages a plurality of different objects to be displayed at specific locations in augmented reality or virtual reality. The data processing unit 114 stores and manages three-dimensional coordinate information for the location of a corresponding object. The data processing unit 114 stores and manages position information of a virtual document written at the location of the object. When a new object for creating a virtual document is created by the mobile terminal 200 or 200a, the data processing unit 114 creates, stores, and manages location information of the created object and a virtual document corresponding thereto. When an object is selected from each of the mobile terminals 200 and 200a or a virtual document is shared at the location of the object, the data processing unit 114 synchronizes the object or the virtual document with each other and displays the virtual document in an augmented reality or virtual reality image. When the object selected from the mobile terminals 200 and 200a matches, the data processing unit 114 displays the shared virtual document.

The data management unit 116 stores and manages the virtual document as data. The data management unit 116 stores and manages the virtual document by matching to an object. The data management unit 116 retrieves previously stored documents of various formats, and processes data conversion to create, insert, or attach the virtual documents. The data management unit 116 recognizes the created virtual document as image or text data, converts the data into documents of various formats, and stores the documents. The data management unit 116 outputs the virtual document converted into data to be printed.

Then, the database 120 stores and manages at least terminal information 122 of the mobile terminals 200 and 200a, user information 124 of the mobile terminals 200 and 200a, virtual document data 126, encryption information 128, first object information 130, second object information 132, and third object information 134. Although the database 120 is included in the server, it may be provided as an independent database server.

As described above, the document processing system 2 of the present invention provides a virtual document at the location of an object displayed in augmented reality or virtual reality among users using the mobile terminals 200 and 200a capable of expressing augmented reality or virtual reality, and shares the virtual document to be viewed in augmented reality or virtual reality.

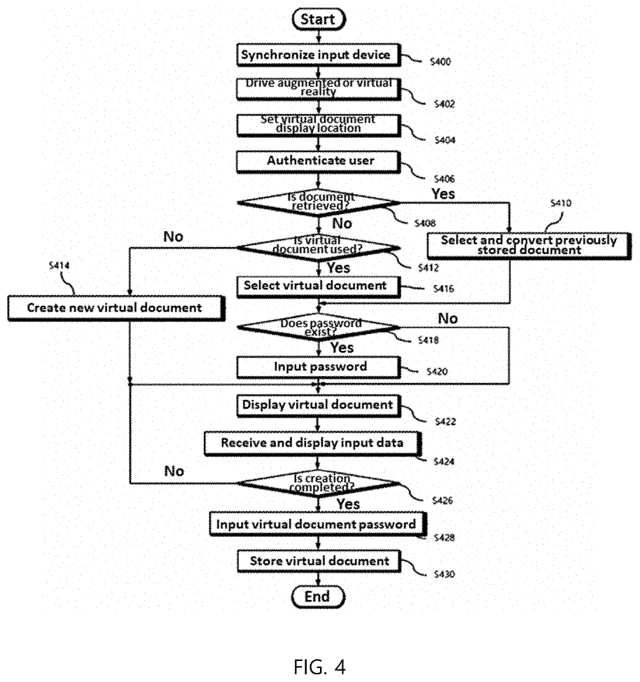

Hereinafter, the processing procedure of the document processing system according to a first embodiment will be described in detail with reference to FIGS. 4 to 7.

In the document processing system 2 of the present invention, the first mobile terminal 200 that creates a virtual document recognizes the input device 300 by synchronizing the input device 300 at step S400.

The first mobile terminal 200 displays an image of augmented reality or virtual reality by driving augmented reality contents or virtual reality contents according to the current location at step S402, and selects an object included in the displayed augmented reality or virtual reality image or creates a new object and sets a virtual document display location at step S404. Here, the object is a target object in the augmented reality or virtual reality image at the current location, and includes, for example, a specific place, objects, buildings, monuments, landmarks and the like located at the specific place, natural environments such as seas, mountains, and sky and the like, tangible and intangible target objects having a story related to the user himself/herself, or target objects desired to be recorded by the user. These objects may include various target objects for creating a virtual document by recording contents that the user desires.

At step S406, the first mobile terminal 200 processes user authentication using the user information, the terminal information, and the like to create a virtual document.

When user authentication is approved at step S408, the first mobile terminal 200 determines whether or not to use a previously stored document to create a virtual document. Here, the previously stored document includes documents written in various formats including text, images and the like, such as Hangul documents, MS-word documents, and PDF documents, which are circulated currently.

That is, when a previously stored document is used as a result of the determination, the first mobile terminal 200 retrieves any one of previously stored documents and selects a corresponding document using the input device 300 or a user's gesture or voice, converts the selected document into image or text data inserted into a virtual document at step S410, and then proceeds to step S418. At this point, the selected document may be inserted into the virtual document as the user selects a part or all of the document. In addition, when a previously stored document is not used as a result of the determination, the first mobile terminal 200 determines whether or not to use a previously created virtual document for the selected object at step S412.

When there is no previously created virtual document for the selected object as a result of the determination or a new virtual document is created, the first mobile terminal 200 proceeds to step S414 and generates a new virtual document at the location of the corresponding object. However, when there is at least one previously stored virtual document at the location of the object, the first mobile terminal 200 selects the virtual document for editing, updating or the like of the previously created virtual document at step S416.

At step S418, the first mobile terminal 200 determines whether the selected virtual document is encrypted. When the virtual document is encrypted as a result of the determination, the first mobile terminal 200 proceeds to step S420 and decrypts the virtual document by inputting encryption information.

At step S422, the first mobile terminal 200 displays the virtual document at the location of the object in the augmented reality or virtual reality image. At this point, the augmented reality or virtual reality image of the object and the virtual document is displayed by image processing such as chroma-key processing or the like so that the virtual document may be created without being hidden by the object.

At step S424, the first mobile terminal 200 receives data input into the virtual document in real-time from the input device 300 or recognizes an input operation of the input device 300, and displays the input data in the augmented reality or virtual reality image.

When creation of the virtual document is completed at step S426 and the created virtual document is a newly created virtual document, the first mobile terminal 200 inputs to set encryption information at step S428. Subsequently, at step S430, the first mobile terminal 200 stores the encrypted virtual document.

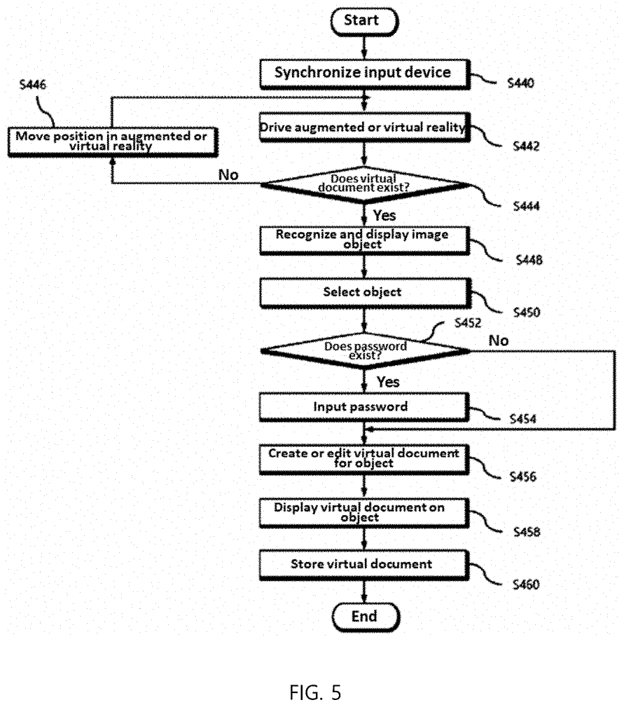

Referring to FIG. 5, in the document processing system of the present invention, the first mobile terminal 200 synchronizes and recognizes the input device 300 at step S440, and displays an image of augmented reality or virtual reality by driving augmented reality contents or virtual reality contents at the current location at step S442.

At step S444, the first mobile terminal 200 determines whether there is an object for which the user desires to create or view a virtual document in the displayed augmented reality or virtual reality image. When there is no such an object as a result of the determination, the first mobile terminal 200 proceeds to step S446 and moves to a location where an object can be selected from the image of augmented reality or virtual reality. However, when there is such an object, the first mobile terminal 200 proceeds to step S448 and recognizes and displays the object in the image of augmented reality or virtual reality so that the corresponding object may be selected.

When the user of the first mobile terminal 200 selects a corresponding object at step S450, it is determined whether there is a password of the selected object at step S452. When there is a password as a result of the determination, password information is input at step S454, and a virtual document is created for the object or a previously created virtual document is edited by inputting contents desired by the user at the location of the object desired by the user through the input device 300 at step S456. At step S458, the virtual document created for the object is displayed in the augmented reality or virtual reality image in real-time. Subsequently, at step S460, the created virtual document is converted and stored as virtual document data of various formats. The virtual document data may include, for example, data of various formats circulated previously, such as Hangul documents, MS-word documents, PDF documents, and the like.

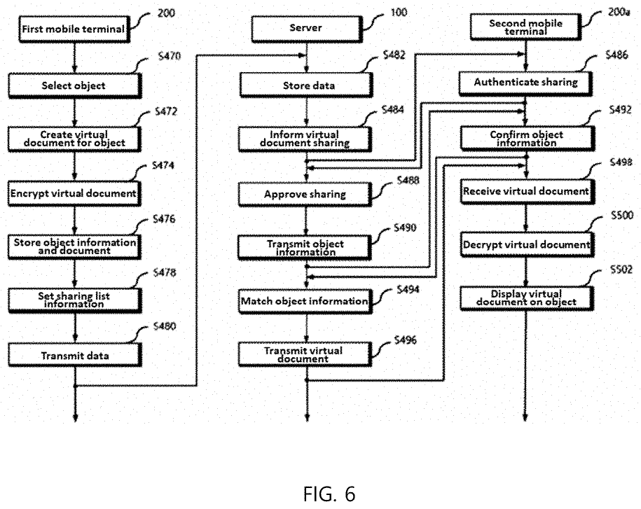

FIG. 6 is a flowchart illustrating a procedure of sharing a virtual document of a document processing system according to the present invention. Here, the first mobile terminal 200 creates a virtual document, and the second mobile terminal 200a shares the virtual document created by the first mobile terminal 200 in augmented reality or virtual reality.

Referring to FIG. 6, in the document processing system of the present invention, the first mobile terminal 200 selects an object displayed in an augmented reality or virtual reality image at step S470, and creates a virtual document for the selected object at step S472. The first mobile terminal 200 inputs encryption information and encrypts the created virtual document at step S474.

At step S476, the first mobile terminal 200 stores object information of the selected object and the encrypted virtual document. At step S478, the first mobile terminal 200 sets and stores information on other users with whom the user desires to share the virtual document, i.e., sharing list information. Subsequently, at step S480, the first mobile terminal 200 transmits data including first object information, second object information (sharing list information), and the virtual document to the server 100.

The server 100 stores the data transmitted from the first mobile terminal 200 at step S482, and transmits notification information informing that the virtual document is shared to the second mobile terminal 200a of a corresponding user through the sharing list information at step S484.

At step S486, the second mobile terminal 200a receives the notification information from the server 100 and processes a sharing authentication procedure for viewing the virtual document. That is, the second mobile terminal 200a authenticates the user as a sharing target by transmitting user information, terminal information, and the like to the server 100.

When the sharing authentication of the second mobile terminal 200a is processed, the server 100 approves sharing at step S488, and transmits the first object information matching the virtual document to the second mobile terminal 200a at step S490.

At step S492, the second mobile terminal 200a confirms the first object information received from the server 100, recognizes the location of the object in augmented reality or virtual reality, and moves to the location.

When the second mobile terminal 200a moves to a location corresponding to the first object information and the current location of the second mobile terminal 200a in augmented reality or virtual reality matches the location of the virtual document to be shared at step S494, the server 100 transmits the virtual document to the second mobile terminal 200a at step S496.

The second mobile terminal 200a receives the virtual document from the server 100 at step S498, and decrypts the virtual document by inputting encryption information at step S500. At this point, the encryption information may be shared and known between the first and second mobile terminals 200 and 200a in advance, or may be transmitted to the second mobile terminal 200a when sharing is approved by the server 100.

Subsequently, the second mobile terminal 200a displays the virtual document at step S502 so that it can be viewed at the location of the corresponding object. At this point, when the displayed virtual document can be edited or a response or a comment is required, the second mobile terminal 200a may edit or write the virtual document in the same manner as the first mobile terminal 200. In this case, the server 100 may perform the processes described above in association with the first mobile terminal 200 to share the virtual document created by the second mobile terminal 200a with the first mobile terminal 200.

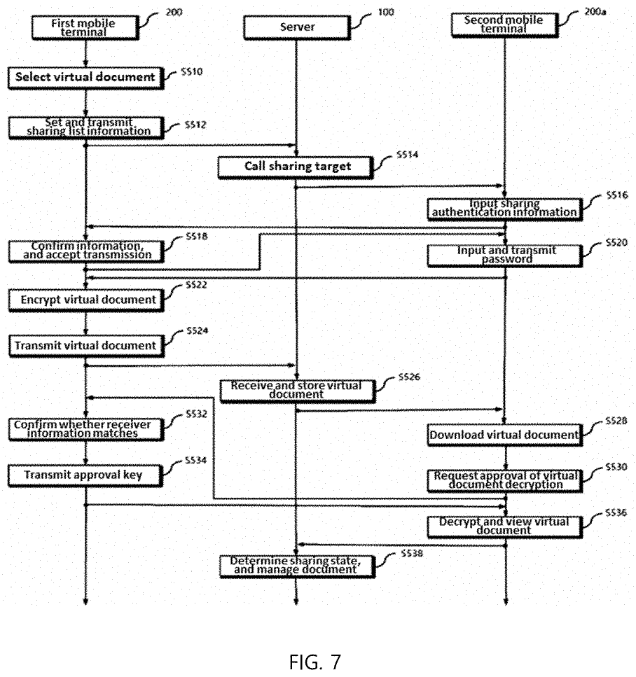

FIG. 7 shows a process of sharing a virtual document between the first and second mobile terminals 200 and 200a through the server 100 in the document processing system 2.

Referring to FIG. 7, in the document processing system 2, the first mobile terminal 200 that has created a virtual document selects a virtual document at the location of an object in an augmented reality or virtual reality image at step S510, prepares sharing list information for sharing the selected virtual document, and transmit the sharing list information to the server 100 at step S512.

At step S514, the server 100 calls the second mobile terminal 200a of a user, who is a sharing target, from the sharing list information and transmits notification information informing that the virtual document is shared. At step S516, the second mobile terminal 200a receives the notification information from the server 100, inputs third object information (sharing authentication information) for authenticating whether or not the user is a sharing target, and transmits the third object information to the first mobile terminal 200. At step S518, the first mobile terminal 200 receives the third object information (sharing authentication information), confirms that the user of the second mobile terminal 200a is a sharing target, and accepts transmission of the virtual document. At step S520, when transmission of the virtual document is accepted by the first mobile terminal 200, the second mobile terminal 200a inputs encryption information for encrypting the virtual document and transmits the encryption information to the first mobile terminal 200.

The first mobile terminal 200 receives the encryption information from the second mobile terminal 200a and encrypts the virtual document with a corresponding encryption key at step S522, and transmits the encrypted virtual document to the server 100 at step S524. The server 100 receives and stores the virtual document transmitted from the first mobile terminal 200 at step S526, and the second mobile terminal 200a downloads the virtual document from the server 100 at step S528.

At step S530, the second mobile terminal 200a requests approval from the first mobile terminal 200 to decrypt the downloaded virtual document. At step S532, the first mobile terminal 200 receives the approval request from the second mobile terminal 200a and confirms whether the user of the second mobile terminal 200a is an authorized sharing target through user information. At step S534, when the user of the second mobile terminal 200a is an authorized sharing target, the first mobile terminal 200 transmits an approval key for approval of decryption to the second mobile terminal 200a. When the approval key is transmitted from the first mobile terminal, the second mobile terminal 200a decrypts and views the virtual document using the transmitted approval key at step S536.

Subsequently, at step S538, when the second mobile terminal 200a views the virtual document, the server 100 determines a sharing state according to log information of the second mobile terminal 200a, whether the virtual document is viewed by the second mobile terminal 200a, viewing time, destroying time of the virtual document, and the like, and manages to preserve or destroy the virtual document in response thereto.

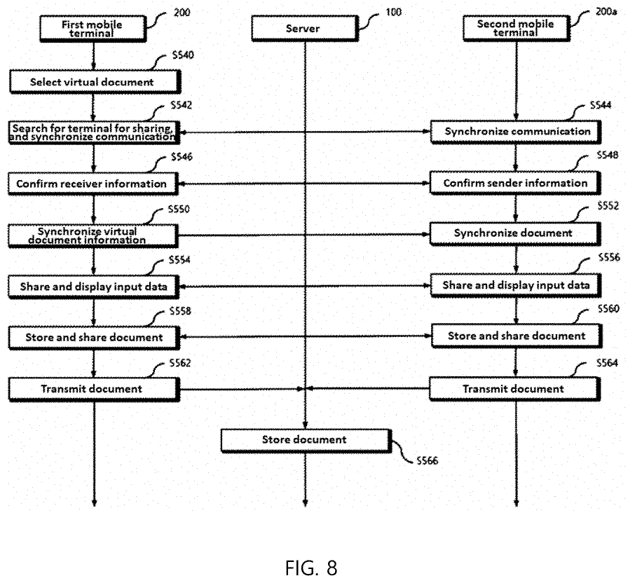

FIG. 8 is a flowchart illustrating a procedure of sharing a virtual document in a P2P method between users of a document processing system. The procedure of this embodiment shows a process of the document processing system 2 for sharing a virtual document between the mobile terminals 200 and 200a in a peer-to-peer (P2P) method using a blockchain technique.

Referring to FIG. 8, at step S540, the document processing system of the present embodiment selects a virtual document desired to be shared by the first mobile terminal 200 of a user who has created the virtual document. At this point, as the virtual document includes previously created and stored documents of various formats, such as Hangul (HWP) files, PDF files, MS-word files, and the like, as well as documents created in augmented reality or virtual reality and stored in advance, which are provided with contents of an object included in an augmented reality or virtual reality image, a document to be displayed on the object may be selected. The document may be converted into an image or text of a corresponding format, and selected to be displayed in the augmented reality or virtual reality image.

At steps S542 and S544, the first mobile terminal 200 searches for and selects at least one second mobile terminal 200a to be shared with, and synchronizes communication with the selected second mobile terminal 200a. Accordingly, the first and second mobile terminals 200 and 200a are connected to share the virtual document with each other.

At step S546, the first mobile terminal 200 confirms user information of the selected second mobile terminal 200a, and at step S548, the selected second mobile terminal 200a confirms user information of the first mobile terminal 200 desired to share virtual documents.

At step S550, when the user information of the second mobile terminal 200a is confirmed, the first mobile terminal 200 requests synchronization by transmitting document information of the virtual document displayed in augmented reality or virtual reality to the second mobile terminal 200a. At step S552, when synchronization of document is requested by the first mobile terminal 200, the second mobile terminal 200a matches the location of the document with respect to the object by synchronizing the document location to the location of the virtual document in augmented reality or virtual reality.

When the first mobile terminal 200 inputs input data into the virtual document and displays and shares the input data in real-time at step S554, the second mobile terminal 200a displays the input data in the virtual document in real-time. Of course, in the opposite case, i.e., when the second mobile terminal 200a inputs and shares input data, the first mobile terminal 200 displays the shared input data in real-time.

At steps S558 and S560, the first and second mobile terminals 200 and 200a respectively store input data so as to be included in the virtual document, and shares the input data with each other. Subsequently, at steps S562 and S564, the first and second mobile terminals 200 and 200a respectively transmit the stored virtual document to the server 100. Accordingly, at step S566, the server 100 stores and manages the virtual document by matching information related to the virtual document, for example, a hash key, time information, a storage location, and the like, to prevent forgery and falsification.

The document processing system 2 of the present embodiment configures management target data as small-scaled data called blocks, and processes the virtual document to be shared using a blockchain based on distributed computing, in which anyone is not allowed to arbitrarily change the blocks, and anyone is allowed to view a result of a change, since the blocks are stored in a distributed data storage environment based on a connection link of a chain shape generated based on a P2P method between the first and second mobile terminals 200 and 200a.

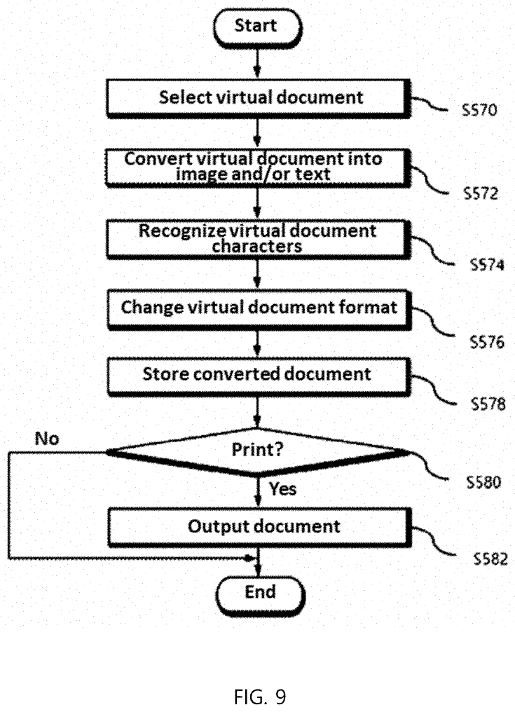

Referring to FIG. 9, in the document processing system 2 of the present invention, each of the first and second mobile terminals 200 and 200a selects a virtual document at step S570, converts the selected virtual document into an image or text at step S572, and recognizes characters included in the virtual document converted into an image or text at step S574. At this point, the characters are recognized using, for example, a handwriting recognition algorithm, an optical character recognition (OCR) algorithm, an image recognition algorithm, or the like. Since the character recognition techniques are well-known techniques already disclosed in various ways, detailed description thereof will be omitted.

The recognized characters are converted into document data conforming to various formats at step S576, and the converted document data are stored at step S578. At this point, document data of various formats may be diversely provided, for example, as Hangul (HWP) files, word files, PDF files, and the like. Subsequently, when it is desired to print the stored document data at step S580, the document data are output to a printing device such as a printer or the like at step S582. At this point, when the input data input by the input device 300 or the input data generated by recognizing an object according to an input operation of the input device 300 is a three-dimensional character, the document data may be printed three-dimensionally as an output material.

A document processing system using augmented reality and virtual reality according to a second embodiment of the present invention processes to provide a virtual test sheet to a test target person, and prepare and submit answer data for the virtual test sheet to the server using various input devices, through the process of user authentication of the test target person, time synchronization between a mobile terminal and a server, encryption and decryption of virtual test sheet data and answer data, and objects recognition, handwriting recognition, and image processing according to writing answers, using a mobile terminal that can express augmented reality or virtual reality.

In a second embodiment of the present invention, the document processing system 2 of the present invention provides a virtual test sheet that can be viewed only by a test target person using augmented reality or virtual reality, processes to write and submit answers to the virtual test sheet, and processes to recognize the answers and prepare a test result. Here, one or more pages may be provided in the virtual test sheet, and the virtual test sheet includes objects for a practical test, as well as a written test.

The document processing system 2 of the present invention may process to take a test by providing a virtual test sheet inside the mobile terminal 200 itself, or may process to take a test by providing a virtual test sheet through the combination of the mobile terminal 200 and the server 100. When a test is performed by the mobile terminal 200 itself, a management device (not shown) connected to a plurality of mobile terminals 200 to integrally manage general matters according to all test procedures from user authentication to answer sheet evaluation may be further provided.

The mobile terminal 200 synchronizes and recognizes the input device 300 in order to write answers of the virtual test sheet.

The mobile terminal 200 scans from the recognized input device 300 to set a display location of the virtual test sheet in the image of augmented reality or virtual reality. At this point, when the display location of the virtual test sheet is set by recognizing, for example, the movement direction, angle, and position of the input device 300, the mobile terminal 200 displays the corresponding display location as a dotted line or the like in the image of augmented reality or virtual reality to inform the test target person. Therefore, the test target person may set the virtual test sheet to be displayed at a location desired by the test target person in the image of augmented reality or virtual reality. At this point, the virtual test sheet is provided by the server 100 in a manner of randomly mixing a plurality of questions and arranging the same questions in different arrangements, and may be displayed as a different test type in each of the mobile terminals 200.

The mobile terminal 200 performs user authentication by inputting or reading user's test identification slip information. The test identification slip information includes, for example, a user name, a test identification number, a date of birth, and the like. At this point, the mobile terminal 200 scans and recognizes biometric information about a fingerprint, an iris, or the like of the user, and compares the biometric information with biometric information stored therein, or transmits the biometric information to the server 100 through the wireless communication network 4 to additionally perform user authentication.

When the user authentication is completed, the mobile terminal 200 synchronizes time with the server 100 through the wireless communication network 4 to generate an encryption key according to the user authentication. The mobile terminal 200 requests virtual test sheet data from the server 100 through the wireless communication network 4, and receives an encryption key and encrypted virtual test sheet data transmitted from the server 100 in response to the request. At this point, when the user authentication is completed without interworking with the server 100, the mobile terminal 200 may process to display the virtual test sheet stored therein at a location set by the user in the augmented reality or virtual reality image without the time synchronization and encryption process.

In the second embodiment, the encryption key includes a master key and additional information. The master key is used to decrypt the encrypted virtual test sheet data or to encrypt answer data, and the additional information includes information for identifying the user when user authentication is performed, for example, time information, terminal information, user information, and the like. The master key is generated by the server 100 during the user authentication and time synchronization and stored in the server 100, and the master key is transmitted from the server 100 to the mobile terminal 200 and stored in the mobile terminal 200 when data is requested. Among the additional information, the time information includes a start time, an end time, a test time, and the like of a corresponding test, and the terminal information includes, for example, a unique identification code of the mobile terminal 200, the size and resolution of the display screen, and the like, and the user information includes, for example, a user name, test identification slip information, and the like. The encryption key is bit-operated in the form of a binary protocol normalized by an encryption algorithm, and is stored in the server 100 and the mobile terminal 200 in the form of a file.

When the encrypted virtual test sheet data is received from the server 100, the mobile terminal 200 decrypts and displays the virtual test sheet data on the screen of augmented reality or virtual reality. That is, when the virtual test sheet data is decrypted, the mobile terminal 200 checks validity of the stored encryption key and decrypts the virtual test sheet data by reading the master key and additional information from the encryption key, i.e., a normalized binary protocol area. The mobile terminal 200 generates an augmented reality or virtual reality screen (view) to display the decrypted virtual test sheet data at a display location in augmented reality or virtual reality, and displays a user signature field on the generated screen. When the user signature field is digitally signed using the input device 300, the mobile terminal 200 provides a virtual test sheet to the user by displaying the decrypted virtual test sheet data at the display location on the augmented reality or virtual reality screen. Here, the digital signature may be used to determine a test start time when the user of the mobile terminal 200 takes a test using the virtual test sheet data.

When answers to the displayed virtual test sheet are written using the input device 300, the mobile terminal 200 receives data from the input device 300 or recognizes the movement of the input device 300 and generates and stores answer data. For example, when the input device 300 is a keyboard, the mobile terminal 200 receives data corresponding to characters input from the keyboard. In addition, when the input device 300 is an object such as a pen mouse, a virtual pen mouse, a virtual keyboard, a user's finger, or the like, the mobile terminal 200 receives data including information needed for handwriting recognition, such as coordinates, moving axis or the like, in order of input time.

Here, the handwriting recognition technique receives data in real-time using, for example, the input device 300 synchronized with the mobile terminal 200, recognizes a corresponding object using object recognition information data of deep learning or machine learning, finds a part (i.e., a pointer) for writing of the object and recognizes the position of the pointer, and generates data by matching information according to movement of the object. At this point, accuracy of handwriting data is increased by re-recognizing the position of the pointer matching the position of the answer written on the virtual test sheet according to zoom in/out, tilt, or the like based on the movement of the input device 300 in the augmented reality or virtual reality image. In addition, accurate handwriting such as spacing or the like may be supported by grasping movement of the pointer of the object. Various techniques related to pointer recognition are already disclosed, for example, in Korean Patent Registration No. 10-1491413 (published on Feb. 6, 2015), ‘a method of generating three-dimensional coordinates using a finger image input into a mono camera of a terminal, and a mobile terminal for generating three-dimensional coordinates using a finger image input into a mono camera’, and thus detailed description thereof will be omitted herein. As another example, the handwriting recognition technique may use a sensor of the mobile terminal 200 to recognize an input operation of the input device 300 or a user's gesture according to handwriting, and generate handwritten data through the input operation or gesture.

The mobile terminal 200 displays the answer data input or written by the input device 300 on the displayed virtual test sheet in real-time. The answer data includes user data and log information corresponding to the answers input or written by the input device 300, image data captured by the camera as is when the answers are written, and the like, and is stored in the mobile terminal 200, and the answer data is stored in synchronization with the server 100 in real-time when the mobile terminal 200 interworks with the server 100. At this point, the answer data is stored as a file of a normalized protocol form, and the user data includes, for example, the number of questions of the virtual test sheet, the number of answers, question numbers, user's answer data corresponding to each of the question numbers, and the like. At this point, the answer data may be generated to include the virtual test sheet and at least one page or more corresponding to each of the questions included in the virtual test sheet.

When writing answer data is completed by the user and whether or not to submit finally generated answer data to the server 100 using a digital signature or the like is determined, the mobile terminal 200 encrypts the answer data using an encryption key and transmits the encrypted answer data to the server 100. Here, when submission of the answer data is finally determined, the answer data is stored and transmitted in the form of a file that cannot be changed, added, or deleted in order to prevent fraudulent activities.

Therefore, when the submitted answer data is received, the server 100 generates second object information 132 including the answer data, decrypts the second object information 132 including the answer data using an encryption key corresponding to the mobile terminal 200, extracts and stores question numbers and user's answer data corresponding thereto from the normalized protocol, and scores by comparing the answer data with previously stored correct answer data, respectively.

In the present invention, the virtual test sheet data may be provided as data for a practical test, as well as a written test sheet. For example, when the practical test is a hairdresser qualification examination, a three-dimensional model image, for example, a mannequin image, having a condition, length, color, and the like of hair is displayed in augmented reality or virtual reality using the mobile terminal 200, and the test target person mounts the input device 300, for example, sensor devices corresponding to beauty tools such as scissors, combs, and the like, and takes a practical test by virtually performing practical test requirements required for qualification as a hairdresser, such as skills of using scissors, combs and the like, on a mannequin. Accordingly, the mobile terminal 200 generates and stores answer data as a three-dimensional image of a mannequin with trimmed hair. Then, the mobile terminal 200 encrypts the answer data, and submits the answer data for the practical test by transmitting the encrypted answer data to the server 100.

To this end, the server 100 is provided with augmented reality contents or virtual reality contents by generating various object packages expressed in augmented reality or virtual reality to take a practical test, and randomly selects an object package according to the subject, evaluation level, and the like of the test target person and displays the object package on the mobile terminal 200 of the test target person. Here, the object package is provided as augmented reality contents or virtual reality contents for one object, in which states or shapes of the object changing in real-time in augmented reality or virtual reality by a test target person during a practical test, e.g., states or shapes changing in real-time according to movement, change, transform, assembly, and/or combination of the object, are diversely created to express changes in the object in real-time during the practical test and submit a final object package corresponding to the practical test result as answer data.

Accordingly, the test target person finally forms a desired practical test result by changing the object in real-time through behaviors such as movement, change, transform, assembly, combination, and the like using the input device 300 such as a sensor device or the like or a gesture of the user's hand in augmented reality or virtual reality.

Since the techniques of transforming, manipulating, or moving objects according to a user's input in an augmented reality or virtual reality environment are well-known techniques diversely disclosed in the art, detailed description thereof will be omitted herein. In addition, it is apparent that various techniques of recognizing and applying behaviors such as moving, changing, transforming, assembling, or combining objects displayed in augmented reality or virtual reality using an input device or a user's gesture in an augmented reality or virtual reality environment, which have already been disclosed, can be applied to the present invention.

Therefore, the mobile terminal 200 displays a three-dimensional model image in augmented reality or virtual reality, extracts feature points according to real-time changes in an object by recognizing movement of the input device 300 for handling the object using a camera, a sensor, or the like or a gesture of the test target person, recognizes and extracts an object of the three-dimensional model transformed according thereto, and forms as a practical test result in augmented reality or virtual reality.

As shown in FIG. 2, the mobile terminal 200 of a second embodiment includes a control unit 202, a wireless communication unit 204, a sensor unit 206, a display unit 208, an augmented/virtual reality driving unit 210, a user authentication unit 212, a document processing unit 216, an encryption processing unit 218, and a storage unit 220.

The controller 202 controls to process the overall operation of the mobile terminal 200. That is, the control unit 202 controls each of the wireless communication unit 204, the sensor unit 206, the display unit 208, the augmented/virtual reality driving unit 210, the user authentication unit 212, the document processing unit 216, the encryption processing unit 218, and the storage unit 220 to provide a virtual test sheet using augmented reality or virtual reality by the mobile terminal 200 itself or in association with the server 100, and the control unit 202 recognizes an input or an operation of the input device 300 to generate and store answer data in the mobile terminal 200, or encrypt answer data stored in the mobile terminal 200 and transmit the encrypted answer data to the server 100.

The wireless communication unit 204 is connected to the server 100 through the wireless communication network 4. The wireless communication unit 204 receives augmented reality contents or virtual reality contents, virtual test sheet data, and an encryption key from the server 100 and transmits encrypted answer data to the server 100 under the control of the controller 202.

The sensor unit 206 includes at least a camera, a handwriting recognition sensor, a fingerprint sensor, and an iris sensor. For example, when an answer is written by the input device 300, the camera captures an image according to the position and movement of the input device 300. The handwriting recognition sensor recognizes handwriting when an answer is written by recognizing a location (coordinates) and a movement direction according to the movement of the input device 300 or a user's gesture. The fingerprint sensor and the iris sensor recognize biometric information about a fingerprint, an iris, or the like of the user of the mobile terminal 200 during user authentication.

The display unit 208 displays an environment for taking a test, for example, a test site, a desk, a white board, and the like, as an image of augmented reality or virtual reality. The display unit 208 displays a virtual test sheet in the image of augmented reality or virtual reality, and displays objects (e.g., a pen mouse, a keyboard, a user's finger, and the like) of the input device 300 captured by the camera in the image of augmented reality or virtual reality. In addition, the display unit 208 recognizes a gesture of the input device 300 or the user using a handwriting recognition sensor, and displays the gesture in the image of augmented reality or virtual reality. At this point, the display unit 208 outputs images on different layers to display the virtual test sheet and the object to be distinguished from each other. When the mobile terminal 200 is, for example, an HMD device, the display unit 208 may output and display the image of augmented reality or virtual reality on the screen or the like.

The augmented/virtual reality driving unit 210 drives to display the augmented reality contents or virtual reality contents on the display unit 208, and drives to display virtual test sheet data stored in the storage unit 220 or transmitted from the server 100 in the image of augmented reality or virtual reality. At this point, the augmented/virtual reality driving unit 210 scans to set a display location of the virtual test sheet in the image of augmented reality or virtual reality from the recognized input device 300, and when the display location of the virtual test sheet is set, it drives to display the corresponding display location as a dotted line or the like to inform the test target person of the display location in the image of augmented reality or virtual reality. The augmented/virtual reality driving unit 210 drives to display the object of the input device 300 recognized by the camera or the handwriting recognition sensor on the upper layer of the displayed virtual test sheet.

The user authentication unit 212 receives user's test identification slip information or recognizes test identification slip information captured by the camera, and compares the test identification slip information with user information and biometric information stored in the storage unit 220, or transmits the test identification slip information, biometric information, and the like to the server 100 to process user authentication. In the case of interworking with the server 100, the user authentication unit 212 synchronizes time with the server 100 through the wireless communication network 4 to generate an encryption key according to the user authentication when the user authentication is completed.

When time synchronization with the server 100 is completed, the document processing unit 216 requests virtual test sheet data from the server 100 through the wireless communication network 4. The document processing unit 216 receives virtual test sheet data and an encryption key from the server 100. At this point, the server 100 transmits encrypted virtual test sheet data. The document processing unit 216 stores the received virtual test sheet data and encryption key in the storage unit 220. In addition, when this is processed by the mobile terminal 200 itself, the document processing unit 216 reads and provides the virtual test sheet data stored in the storage unit 220 to the augmented/virtual reality driving unit 210 when user authentication is completed. The document processing unit 216 transmits answer data encrypted by the encryption processing unit 218 to the server 100 through the wireless communication network 4.

The encryption processing unit 218 checks validity of the encryption key stored in the storage unit 220, and decrypts the virtual test sheet data using the encryption key when the encryption key is valid. The encryption processing unit 218 provides the decrypted virtual test sheet data to the augmented/virtual reality driving unit 210 to be displayed. When the user writes an answer on the displayed virtual test sheet using the input device 300, the encryption processing unit 218 receives the data transmitted from the input device 300 or an image of the input device captured by the camera, and generates and stores answer data in the storage unit 220. The encryption processing unit 218 encrypts the answer data using the encryption key.

In addition, the storage unit 220 stores the user information including at least the test identification slip information, biometric information, and the like of the user, the encryption key, the virtual test sheet data, and the answer data.

Referring to FIG. 1 again, the input device 300 is set to enable wireless communication with the mobile terminal 200, and is synchronized with the mobile terminal 200 so that the position of the pointer or the position of the keyboard displayed on the image in augmented reality or virtual reality is recognized. When the input device 300 is synchronized by the mobile terminal 100, it transmits the data written or input by the user on the displayed virtual test sheet to the mobile terminal 200 in real-time. At this point, when the input device 300 is a pen mouse, a keyboard, or a touchpad, the input device 300 transmits the input data to the mobile terminal 200 through the wireless communication network 4 in real-time, and when the input device 300 is a virtual pen mouse or a virtual keyboard, the mobile terminal 200 recognizes information, such as the coordinates of the pointer position, the moving axis, and the like according to the input operation of the virtual pen mouse, or characters input from the virtual keyboard in real-time by recognizing an image captured by a camera or data recognized by the handwriting recognition sensor, for example, the position of a virtual pen mouse, a virtual keyboard, or a user's finger.

When a virtual input space for writing answers is displayed on a virtual test sheet by the mobile terminal 200 after the input device 300 is synchronized with the mobile terminal 200, answers are written in the input space, and input data is transmitted to the mobile terminal 200 in real-time. At this point, when answers are written by handwriting using a virtual pen mouse or the like, the input device 300 recognizes spatial coordinates and object matching information corresponding to the operation of the input device according to the handwriting, and transmits the recognized information as input data. Of course, it is possible to recognize an image captured by the camera of the mobile terminal 200 or handwriting according to movement of the virtual pen mouse recognized by the handwriting recognition sensor, and transmit input data to the mobile terminal 200. In addition, when the input device 300 is a virtual keyboard, the position of a user's finger is recognized using the camera of the mobile terminal 200, and a position corresponding to each input character is recognized and transmitted as input data.

In addition, the server 100 is provided with augmented reality contents or virtual reality contents for providing a virtual test sheet to a test target person using augmented reality or virtual reality, and provides the contents to the mobile terminal 200 through the wireless communication network 4. At this point, the server 100 may receive user information, biometric information, terminal information, and the like for each of a plurality of mobile terminals 200, and register and manage information on the users, i.e., test target persons.

The server 100 authenticates the user of the mobile terminal 200, synchronizes time of the mobile terminal 200, and generates and stores an encryption key corresponding to the user of the mobile terminal 200. At this point, the server 100 may receive the user's test identification slip information from the mobile terminal 200 and process user authentication, and further receive biometric information about a fingerprint, an iris, or the like of the user to additionally process user authentication. In addition, the server 100 generates and stores the encryption key as a file of a normalized protocol form.

When the user authentication is completed, the server 100 receives a request for virtual test sheet data from the mobile terminal 200 through the wireless communication network 4, and transmits an encryption key and encrypted virtual test sheet data to the mobile terminal 200. At this point, the server 100 transmits virtual test sheet data of a different test type to each of the mobile terminals 200 by randomly mixing a plurality of questions stored in the database 120 and arranging the same questions in a different way.

When encrypted answer data is transmitted from the mobile terminal 200, the server 100 generates second object information 132 including the encrypted answer data, and decrypts and stores the answer data encrypted using an encryption key corresponding to the mobile terminal 200. At this point, when the answer data is decrypted, the server 100 attaches a digital signature for confirming that the answer data has been submitted, and processes scoring, evaluation, and the like.

The server 100 recognizes answers matching the question numbers from the decrypted answer data included in the second object information 132, compares the answers with the first object information (correct answer data) stored in advance, and processes scoring, evaluation, and the like. When the user's answers are handwritten, the server 100 recognizes the answer for each question number by determining the three-dimensional coordinates and the moving axis according to the input operation of the input device 300 included in the answer data, or recognizes the answer for each question number using a handwriting recognition algorithm, an optical character recognition (OCR) algorithm, an image recognition algorithm, or the like through image data. At this point, when it is difficult to recognize an answer (e.g., when the handwriting recognition rate is 60 to 70% or less), the server 100 may request the manager confirmation of answer to determine the answer. In this case, fraudulent activities such as correction or the like can be prevented by providing only the user's answers to the manager without providing other information. In addition, when the virtual test sheet is for a practical test, the server 100 may receive answer data from the mobile terminal 200 and transfer only the user's answers of the practical test result to the manager (or scorer) to evaluate.

In addition, when an error such as an equipment error, a communication error, or the like occurs in the mobile terminal 200 or the input device 300 during a test, and the test cannot be performed, the server 100 stops the user's test time until corresponding equipment is replaced or the source of the error is resolved, extends the test time as much as the delayed time after the replacement or resolution in order to remove the disadvantage of the user, and records, stores, and manages the suspended test time, equipment or communication error states, test resuming time, and the like in the log information.

The communication unit 104, which is one of the components of the server 100, processes to perform data communication with a plurality of mobile terminals 200 through the wireless communication network 4. The communication unit 104 receives user information and answer data from the mobile terminal 200, and transmits augmented reality contents or virtual reality contents, virtual test sheet data, and an encryption key to the mobile terminal 200.

The contents providing unit 106 is provided with augmented reality contents or virtual reality contents that allows a user to take a test using a virtual test sheet, and provides the augmented reality contents or virtual reality contents to the mobile terminal 200 through the communication unit 104.

The user authentication unit 108 receives user information from the mobile terminal 200 and authenticates whether the user is a test target person. The user authentication unit 108 may additionally process user authentication through the biometric information about a fingerprint, an iris, or the like transmitted from the mobile terminal 200.

The encryption processing unit 110 generates and stores an encryption key in response to the mobile terminal 200 for which the user authentication is completed. The encryption processing unit 110 encrypts the virtual test sheet data using the encryption key. When answer data is transmitted from the mobile terminal 200, the encryption processing unit 110 decrypts the answer data using an encryption key corresponding to the mobile terminal 200.

The data providing unit 112 manages to store and register a plurality of virtual test sheet data according to a written test and a practical test in the database 120. When a request for a virtual test sheet is received from the mobile terminal 200, the virtual test sheet data providing unit 112 randomly extracts a plurality of questions stored in the database 120, and generates and stores virtual test sheet data, and the encryption processing unit 110 encrypts and transmits the virtual test sheet data to the mobile terminal 200.

The data processing unit 114 recognizes and scores or evaluates answers corresponding to the questions from the answer data decrypted by the encryption processing unit 110. The data processing unit 114 extracts the question numbers of a normalized protocol and user's answers corresponding thereto from the received answer data and stores them, and recognizes each of them in various ways. For example, the data processing unit 114 recognizes the answers using matching information of the three-dimensional spatial coordinates and the object corresponding to the operation of the input device 300 according to writing of the answers. In addition, when the answer data is handwritten, the data processing unit 114 may recognize handwritten answers from an image included in the answer data using, for example, a handwriting recognition, object recognition, or image recognition technique. When it is difficult to recognize an answer, the data processing unit 114 may request the manager to confirm the answer.

The data management unit 116 processes scoring by comparing the answers recognized by the data processing unit 114 with the first object information (correct answer data) stored in the database 120. When the answers recognized by the data processing unit 114 is handwritten, the data management unit 116 may request the manager to confirm and determine the answers according to a handwriting recognition rate. In addition, when there is no first object information (correct answer data), for example, when the answer data is a practical test result, the data management unit 116 may transfer the answer data to the manager (or a scorer) to evaluate. The data management unit 116 generates third object information 134 including evaluation information corresponding to the scoring or evaluation result and stores the third object information in the database 120.

In addition, the database 120 stores and manages at least the third object information 134 including terminal information of the mobile terminal 200, user information of the mobile terminal 200, virtual test sheet data, encryption key, correct answer data, and answer data and evaluation information. Although the database 120 is included in the server, it may be provided as an independent database server.

As described above, the document processing system 2 of the present invention provides a test target person with a virtual test sheet in augmented reality or virtual reality using a mobile terminal capable of expressing augmented reality or virtual reality, processes to write answers using an input device, and recognizes and scores the answer data.

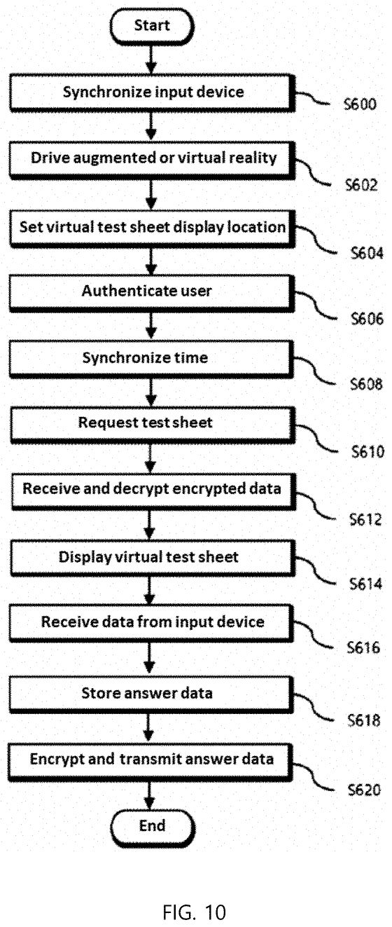

FIG. 10 is a flowchart illustrating a processing procedure of a document processing system using augmented reality and virtual reality according to a second embodiment of the present invention. This procedure is processed by the mobile terminal 200 capable of expressing augmented reality or virtual reality and the server 100 associated with each other.

Referring to FIG. 10, the document processing system 2 of the present invention synchronizes and recognizes the mobile terminal 200 capable of expressing augmented reality or virtual reality and the input device 300 to write answers of a virtual test sheet at step S600.

At step S602, the mobile terminal 200 displays an augmented reality or virtual reality image by driving augmented reality contents or virtual reality contents.

At step S604, a virtual test sheet display location is set using the recognized input device 300 so that the virtual test sheet may be displayed at a location desired by the user of the mobile terminal 200, i.e., a test target person, in the augmented reality or virtual reality image. At this point, when the display location of the virtual test sheet is set by recognizing, for example, the movement direction, angle, and position of the input device 300, the mobile terminal 200 displays the display location as a dotted line or the like to inform the test target person of the display location on the screen of augmented reality or virtual reality.

At step S606, user authentication is processed by inputting or reading test identification slip information using the mobile terminal 200. That is, the mobile terminal 200 inputs a user name, a test identification slip number, and the like or scans the test identification slip using a camera, and compares them with previously stored information or transmits them to the server 100 to process user authentication. At this point, the mobile terminal 200 may process user authentication using a fingerprint, an iris, or the like of the test target person.

At step S608, when user authentication is completed, time is synchronized between the mobile terminal 200 and the server 100 through the wireless communication network 4. At this point, the server 100 generates and stores an encryption key corresponding to the mobile terminal 200 according to time synchronization.

At step S610, the mobile terminal 200 requests virtual test sheet data from the server 100 through the wireless communication network 4. In response thereto, the server 100 transmits encrypted virtual test sheet data and an encryption key to the mobile terminal 200. At step S612, the mobile terminal 200 receives the encrypted data, i.e., the encrypted virtual test sheet data and the encryption key, from the server 100, and decrypts the encrypted test sheet data using the encryption key. At this point, the mobile terminal 200 checks validity of the encryption key.

At step S614, the mobile terminal 200 displays a virtual test sheet at a set display location of the augmented reality or virtual reality image on the basis of the decrypted virtual test sheet data. At step S616, when answers to the displayed virtual test sheet are written using the input device 300, the mobile terminal 200 receives input data from the input device 300 or receives input data according to the movement of the input device 300. At step S618, the mobile terminal 200 generates and stores answer data for the virtual test sheet through the input data. Subsequently, at step S620, the mobile terminal 200 encrypts the answer data using the encryption key and transmits the encrypted answer data to the server 100.

Accordingly, the server 100 decrypts the answer data transmitted from the mobile terminal 200 using the encryption key, recognizes answers to the questions of the virtual test sheet, and processes scoring by comparing the answers with correct answer data.

As another aspect of this embodiment, when the document processing system 2 is not associated with the server 100, i.e., when the mobile terminal 200 processes by itself, the mobile terminal 200 may display the virtual test sheet stored therein on the augmented reality or virtual reality image, write answer data using the input device 300, and store the answer data therein, without performing the time synchronization process (S608), the test sheet request process (S610), and the encryption data reception and data decryption process (S612) described above. In the case of the second embodiment, answer data may be collected, recognized, and evaluated by a separate management device (not shown) connected to a plurality of mobile terminals 200.

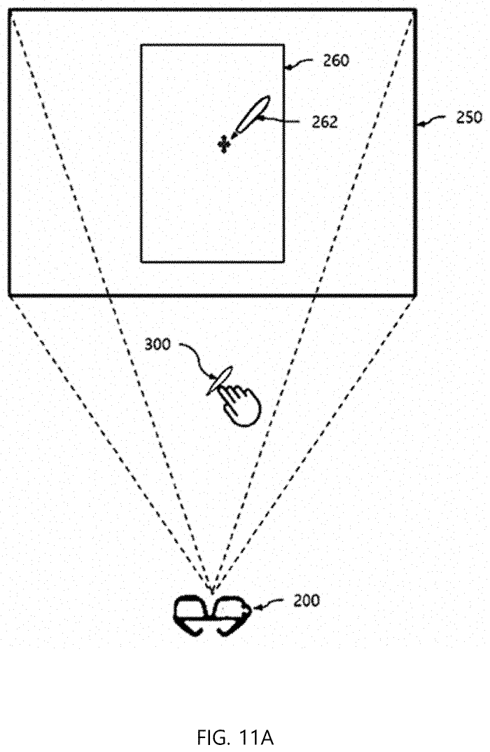

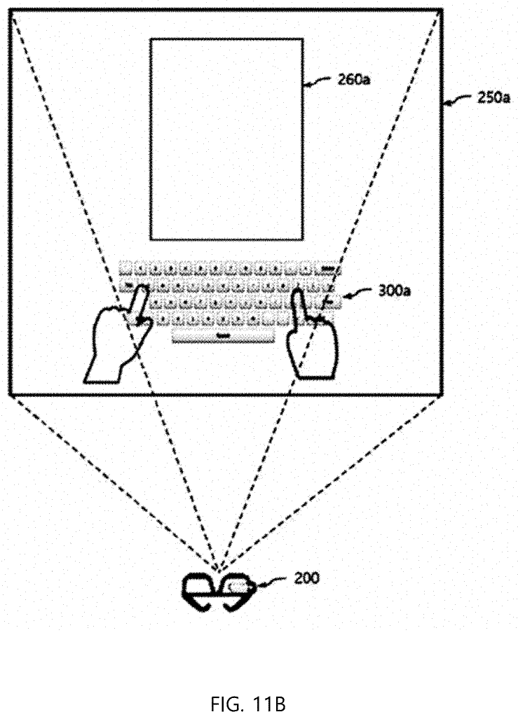

FIGS. 11a and 11b are views showing a virtual test sheet and an input device on an augmented reality or virtual reality screen according to embodiments of the present invention.

Referring to FIG. 11a, a case in which the mobile terminal 200 is an HMD device and the input device 300 is a pen mouse will be described as an example of the document processing system 2 of a second embodiment.

A test site, a desk, a white board, and the like are displayed on the augmented reality or virtual reality screen 250 of the second embodiment using an augmented reality image or a virtual reality image, and a virtual test sheet 260 is displayed on the augmented reality or virtual reality screen 250, and a pen mouse image 262 for writing answers is displayed on the virtual test sheet 260 by recognizing movement of the pen mouse through the camera of the HMD device.

Accordingly, the mobile terminal 200 generates answer data by recognizing three-dimensional spatial coordinates and a moving axis according to movement of the pen mouse. At this point, the mobile terminal 200 synchronizes the position or the like of the pointer by the pen mouse, recognizes three-dimensional spatial coordinates and the moving axis according to the image captured by the camera or the movement of the pen mouse recognized by the handwriting recognition sensor, also recognizes an object that moves the pen mouse, i.e., matching information corresponding to the position of a finger, and generates and stores input data.

Of course, the mobile terminal 200 may also generate answer data by recognizing handwriting using the image captured by the camera or the handwriting recognition sensor.

Referring to FIG. 1ib, the document processing system 2 according to a second embodiment is an example in which an HMD device is used as the mobile terminal 200 and a virtual keyboard is used as the input device 300a.

In this case, the virtual test sheet 260a and the virtual keyboard 300a are displayed on the augmented reality or virtual reality screen 250a, and input of characters at a specific location on the virtual keyboard 300a is recognized by recognizing the location of an object, i.e., a finger, through the camera. At this point, input data is recognized by displaying the finger on the virtual keyboard as if an object is directly typing on the virtual test sheet.

Accordingly, the mobile terminal 200 displays the recognized characters on the virtual test sheet 260a, and generates and stores answer data through these processes.

Of course, although not shown in the drawing, when the mobile terminal 200 is a smartphone or a tablet PC, an augmented reality or virtual reality screen is displayed on a display panel, and the virtual test sheet and the input device 300 are displayed on the screen.

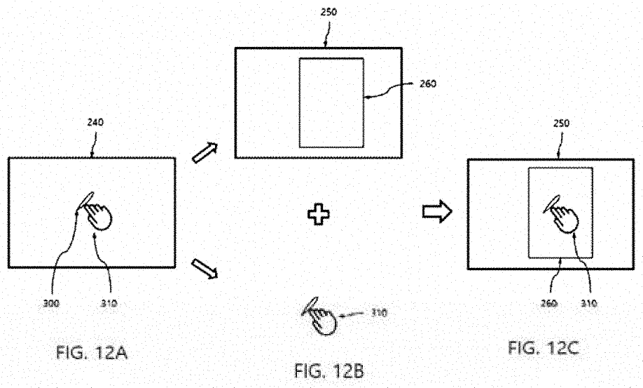

In addition, FIG. 12 is a view for explaining a process of displaying an object of an input device on a virtual test sheet according to the present invention.

Referring to FIG. 12, in the embodiment of FIG. 11a, an object 310 is extracted from an image of the camera capturing the object 310 that moves the pen mouse 300 (FIG. 12(a)), and as the pen mouse 300 of the virtual image and the extracted object 310 are chroma-key processed on the image of the virtual test sheet 260 (FIG. 12(b)) so that the pen mouse 300 and the object 310 are displayed on the virtual test sheet 260 displayed on the augmented reality or virtual reality screen 250, the image is synthesized to display the object 310 on the upper layer of the virtual test sheet 260 (FIG. 12(c)).

Since all augmented reality or virtual reality images are located on the upper layer, the object is hidden by the virtual test sheet image. To solve this problem, the object is extracted from the augmented reality or virtual reality screen 250 using an image object extraction algorithm, and the location where the object part is displayed on the virtual test sheet is transparently processed to display the image of the object on the virtual test sheet.

1. A document processing system using augmented reality and virtual reality, the system comprising:
an input device displayed in an augmented reality or virtual reality image; and
a plurality of mobile terminals capable of expressing the augmented reality and virtual reality,
the mobile terminals for sharing a virtual document between users in real-time by synchronizing and recognizing the input device, displaying a plurality of objects in the augmented reality or virtual reality image, selecting one object by using the input device or by recognizing any one among a gesture and a voice of a user, displaying to create at least one page of virtual document including contents related to the object or desired to be recorded by the user at a location of the selected object, and displaying the created virtual document for another user to view or write in real-time in the augmented reality or virtual reality image.

2. The system according to claim 1, wherein the mobile terminal selects any one among previously stored document data by recognizing a user's gesture using the input device or through a camera or a sensor of the mobile terminal or recognizing a user's voice through the input device or a microphone of the mobile terminal, and retrieves the selected document data and processes at least any one among creating, writing, changing, and deleting the virtual document.

3. The system according to claim 1, wherein the mobile terminal receives input data from the input device, or generates input data by recognizing an input operation of the input device using a camera or a sensor of the mobile terminal, or recognizing a user's voice using the input device or a microphone of the mobile terminal, and creates the virtual document by inputting the input data into the virtual document in real-time.

4. The system according to claim 2, wherein the mobile terminal encrypts the virtual document to be shared only with authorized users, prepares sharing list information of the authorized users, and shares the virtual document when another user is a mobile terminal of an authorized user included in the sharing list information.

5. The system according to claim 4, wherein the mobile terminal converts the virtual document into image or text document data and stores the document data, and processes the converted document data to be printed.

6. The system according to claim 4, further comprising a server for relaying the virtual document to be shared between the mobile terminals.

7. A document processing method using augmented reality and virtual reality, the method comprising the steps of:
synchronizing and recognizing an input device, by a first mobile terminal capable of expressing augmented reality or virtual reality;
displaying an image of augmented reality or virtual reality by driving augmented reality contents or virtual reality contents according to a current location, and displaying an object in the image of augmented reality or virtual reality, by the first mobile terminal;
creating the virtual document by selecting the displayed object using the input device, generating a virtual document at a location of the selected object, and inputting input data of the input device in real-time, by the first mobile terminal;
sharing the created virtual document to be viewed in the image of augmented reality or virtual reality, by the first mobile terminal; and
displaying, when at least one second mobile terminal selects an object corresponding to the virtual document shared in the image of augmented reality or virtual reality, the virtual document created by the first mobile terminal to be viewed or written.

8. The method according to claim 7, wherein the step of creating the virtual document further includes the steps of retrieving any one of document data previously stored in the first mobile terminal without generating the virtual document, converting the retrieved document data into image or text data inserted into the virtual document, and inserting the image or text data into the virtual document.

9. The method according to claim 7, wherein the sharing step includes the steps of encrypting the virtual document by the first mobile terminal, preparing sharing list information for the second mobile terminal permitted to share the virtual document, and decrypting the virtual document and allowing the second mobile terminal included in the sharing list information to view the virtual document.
